(19) United States
(12) Patent Application Publication
(10) Pub. No.: US 2020/0172661 A1
(43) Pub. Date: Jun. 4, 2020

(54) FOAMABLE THERMOPLASTIC POLYESTER COPOLYMER

(71) Applicant: SABIC GLOBAL TECHNOLOGIES B.V., BERGEN OP ZOOM (NL)

(72) Inventors: Bander Al-Farhood, Geleen (NL); Roshan Kumar Jha, Geleen (NL); Mark Berix, Geleen (NL); Nitin S. Gadigone, Geleen (NL)

(21) Appl. No.: 16/617,293

(22) PCT Filed: Jun. 5, 2018
(86) PCT No.: PCT/EP2018/064687

§ 371 Date: Nov. 26, 2019

(30) Foreign Application Priority Data
Jun. 7, 2017 (EP) 17174727.2

(51) Int. Cl. C08G 63/13; B29C 44/50; B29C 44/34

(52) U.S. Cl. CPC C08G 63/13; B29K 2067/003; B29C 44/3449; B29C 44/50

(57) ABSTRACT

The present invention relates to a thermoplastic polyester copolymer comprising 50-1000 ppm with regard to the total weight of the thermoplastic polyester copolymer of moieties derived from an alcohol having ≥3 hydroxy moieties. Such thermoplastic polyester copolymer allows for the production of high-quality foamed articles, whilst reducing the need for additives that are to be incorporated in the copolymer.

The present invention relates to a thermoplastic polyester copolymer having improved foamability properties. The invention further relates to a process for production of such thermoplastic polyester copolymer. The invention also relates to foamed objects comprising such thermoplastic polyester copolymer.

Thermoplastic foamed articles are increasingly finding application in a wide array of outlets. To produce such foamed articles, various thermoplastics are available and are being developed.

A particular family of thermoplastic materials that are widely acknowledged for their advantageous material properties are thermoplastic polyesters. Amongst others, one of the particular advantages of thermoplastic polyesters is their recyclability. In many countries, collection of waste thermoplastic polyesters is well established, and waste thermoplastic polyesters may be processed by various processes including depolymerisation processes to obtain materials that can be further converted to a useable application. Further advantageous properties of thermoplastic polyesters include their high temperature resistance, fatigue resistance and thermoformability.

For example for these reasons, there is a desire to be able to produce foamed objects from thermoplastic polyesters. Foamed objects are advantageous for many reasons, amongst others that they demonstrate an excellent balance of weight to mechanical properties, allowing to produce for example objects that provide a mechanical structural function at a very light weight. Typical densities of suitable thermoplastic foams are below 100 kg/m³.

A disadvantage of thermoplastic polyesters is that in homopolymer form they are not intrinsically foamable, such that further measures are to be taken to ensure that a foamed article can be manufactured using thermoplastic polyesters. For example, the thermoplastic polyester materials may be melt compounded with chain extenders. This however induces a substantial quantity of such chain extenders to be incorporated, like up to 5 wt %, which negatively influences the material properties and costs of the thermoplastic polyester material.

For amongst others that reason, there is a desire to have access to thermoplastic polyester materials suitable for producing foamed objects, wherein the quantity of additives incorporated in the thermoplastic polyester is reduced.

This has now been achieved according to the present invention by a thermoplastic polyester copolymer comprising 50-1000 ppm with regard to the total weight of the thermoplastic polyester copolymer of moieties derived from an alcohol having ≥3 hydroxy moieties.

Such thermoplastic polyester copolymer allows for the production of high-quality foamed articles, whilst reducing the need for additives that are to be incorporated in the copolymer. In particular, it reduces the need for incorporation of chain extenders in the copolymer.

It is particularly preferred that the thermoplastic polyester copolymer is a polymer selected from a poly(ethylene terephthalate) copolymer, a poly(trimethylene terephthalate) copolymer, a poly(butylene terephthalate) copolymer, a poly(ethylene naphthalate) copolymer, or a poly(ethylene furanoate) copolymer. For example, the thermoplastic polyester copolymer may be a poly(ethylene terephthalate) copolymer. Alternatively, the thermoplastic polyester copolymer may be a poly(ethylene furanoate) copolymer.

In the context of the present invention, a poly (ethylene terephthalate) copolymer is also referred to as a PET copolymer; a poly(trimethylene terephthalate) copolymer as a PTT copolymer; a poly(butylene terephthalate) copolymer as a PBT copolymer; a poly(ethylene naphthalate) copolymer as a PEN copolymer; and a poly(ethylene furanoate) copolymer as a PEF copolymer.

The thermoplastic polyester copolymer may for example comprise 95.0 wt %, preferably 98.0 wt %, more preferably 99.0 wt % of moieties derived from a dicarboxylic acid or a diester thereof and an alkylene diol, with regard to the total weight of the thermoplastic polyester copolymer. The dicarboxylic acid or diester thereof may for example comprise 4-20 carbon atoms. The dicarboxcylic acid or diester thereof may for example be an aromatic dicarboxylic acid or diester thereof, preferably an aromatic dicarboxylic acid or diester thereof comprising 4-20 carbon atoms. The dicarboxylic acid or diester thereof may for example be selected from terephthalic acid, dimethyl terephthalate, isophthalic acid, 2,6-naphthalenedicarboxylic acid, dimethyl-2,6-naphthalenedicarboxylate, 2,5-furandicarboxylic acid, dimethyl-2,5-furandicarboxylate, or succinic acid.

The alkylene diol may for example be an alkylene diol comprising 2-10 carbon atoms. The alkylene diol may for example be an aliphatic alkylene diol, preferably an aliphatic alkylene diol comprising 2-10 carbon atoms. The alkylene diol may for example be selected from ethylene glycol, propanediol, 1,4-butanediol, or cyclohexanedimethanol.

For example, the thermoplastic polyester copolyester may comprise ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or diester thereof may for example be selected from terephthalic acid, dimethyl terephthalate, isophthalic acid, 2,6-naphthalenedicarboxylic acid, dimethyl-2,6-naphthalenedicarboxylate, 2,5-furandicarboxylic acid, or succinic acid, and wherein the alkylene diol may for example be selected from ethylene glycol, propanediol, 1,4-butanediol, or cyclohexanedimethanol.

The PET copolymer may for example be a copolymer comprising ≥95.0 wt %, preferably ≥98.0 wt %, more preferably ≥99.0 wt % of moieties derived from a terephthalic acid or dimethyl terephthalate and ethylene glycol, with regard to the total weight of the PET copolymer.

The PTT copolymer may for example be a copolymer comprising ≥95.0 wt %, preferably ≥98.0 wt %, more preferably ≥99.0 wt % of moieties derived from a terephthalic acid or dimethyl terephthalate and 1,3-propanediol, with regard to the total weight of the PTT copolymer.

The PBT copolymer may for example be a copolymer comprising ≥95.0 wt %, preferably ≥98.0 wt %, more preferably ≥99.0 wt % of moieties derived from a terephthalic acid or dimethyl terephthalate and 1,4-butanediol, with regard to the total weight of the PBT copolymer.

The PEN copolymer may for example be a copolymer comprising ≥95.0 wt %, preferably ≥98.0 wt %, more preferably ≥99.0 wt % of moieties derived from a 2,6-naphthalenedicarboxylic acid or dimethyl-2,6-naphthalenedicarboxylate and ethylene glycol, with regard to the total weight of the PEN copolymer.

The PEF copolymer may for example be a copolymer comprising ≥95.0 wt %, preferably ≥98.0 wt %, more preferably ≥99.0 wt % of moieties derived from 2,5-furandicarboxylic acid or dimethyl-2,5-furandicarboxylate and ethylene glycol, with regard to the total weight of the PEF copolymer.

It is particularly preferred that the thermoplastic polyester copolymer comprises ≥95% of moieties derived from ethylene glycol and terephthalic acid or a diester thereof, with regard to the total weight of the thermoplastic polyester copolymer.

In certain particular embodiments of the present invention, the thermoplastic polyester copolymer has an intrinsic viscosity of ≥0.60 dl/g and ≤2.00 dl/g as determined in accordance with ASTM D2857-95 (2007). More preferably, the thermoplastic polyester copolymer has an intrinsic viscosity of ≥0.60 and ≤1.50 dl/g, even more preferably ≥0.70 and ≤1.20 dl/g, further even more preferably ≥0.80 and ≤1.00 dl/g.

The thermoplastic polyester copolymer according to the present invention may for example comprise 100-500 ppm with regard to the total weight of the thermoplastic polyester copolymer of moieties derived from an alcohol having 3 hydroxy moieties, more preferably 150-300 ppm.

The presence of moieties derived from such alcohol leads to branching of the polymeric chains of the thermoplastic polyester copolymer. It is believed that a certain degree of branching present in the thermoplastic polyester copolymer may contribute to the improvement of the melt stability of the polymer. This is in particular relevant in the formation of foamed materials. In the process of foaming, a foaming agent is supplied to the polyester at certain stage, preferably in a situation where the polyester is in molten condition. The foaming agent executes its expanding function commonly upon exiting a melt processing device, such as a melt extruder or an injection moulding machine. The polyester comprising the foaming agent is in such situation formed into a desired shape for example by entering a portion of the molten material in a mould or by shaping the material into a desired profile by forcing it through an extruder die. The foaming agent then provides its expanding function by generation of gaseous material, resulting in the formation of foam cells. The thermoplastic polyester material is during formation of these foam cells still in molten condition, and needs to solidify under the right circumstances when the foam cells have been formed, thus freezing the foam shape.

In this foaming process, it is required that the polyester has a certain high melt strength, to ensure that the foam cells retain their form during the solidification process to result in a foamed article having the desired structure. The presence of moieties derived from an alcohol having 3 hydroxy moieties, as is the case in the copolymer of the present invention, is understood as supportive of the branching of the polyester and thus of the melt strength.

In particular, the moieties derived from an alcohol having ≥3 hydroxy moieties may for example be moieties derived from compound according to the formula:

[R1OHₙ

wherein R1 is a moiety comprising 1-10 carbon atoms and wherein n is an integer ≥3 and ≤6. Preferably, R1 is a moiety comprising 3-6 carbon atoms. Also preferably, n is an integer of ≥4 and ≤6. Even more preferably, n is 4.

It is preferred that R1 is a moiety selected from methyl, ethyl, propyl, tert-butyl, neopentyl, or hexamethylethyl. Particularly preferably, R1 is a tert-butyl moiety.

The alcohol having ≥3 hydroxy moieties may for example be selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxynnethyl)-1,4-butanediol, tris(2-hydroxyethyl)methane, or tetrakis(2-hydroxyethyl)methane. It is particularly preferred that the alcohol having ≥3 hydroxy moieties is selected from pentaerythritol, 1,1,2,2-tetrahydroxyethane, or tetrakis(2-hydroxyethyl)methane. Alternatively, the alcohol having ≥3 hydroxy moieties may be selected from trihydroxymethane, glycerol, 1,3,5-pentanetriol or tris(2-hydroxyethyl)methane. Alternatively, the alcohol having 3 hydroxy moieties may be selected from xylitol, hexahydroxyethane, or 2,2,3,3-tetrakis(hydroxynnethyl)-1,4-butanediol.

The thermoplastic polyester copolymer according to the present invention may for example be produced via a polymerisation process for the production of thermoplastic polyesters common in the art. For example, the thermoplastic polyester copolymer may be produced via a process involving a first esterification step and a second polycondensation step.

The first esterification step involves reacting a dicarboxylic acid or diester thereof with an alkylene diol and an alcohol having ≥3 hydroxy moieties. The first esterification step typically comprises a paste mixing vessel and one or more esterification reactor(s). For example, a composition comprising the alkylene diol, the dicarboxylic acid or diester thereof, the alcohol having ≥3 hydroxy moieties, a catalyst such as antimony triacetate and optionally further compounds such as further comonomers may be pre-mixed in the paste mixing vessel, from which the composition is introduced into the one or more esterification reactor(s). In a particular embodiment, a composition comprising ethylene glycol, terephthalic acid, an alcohol having ≥3 hydroxy moieties and antimony triacetate may be pre-mixed in the paste mixing vessel. The molar ratio of the alkylene diol to the dicarboxylic acid or diester thereof preferably is ≥1.1, such as ≥1.1 and ≤3.0, preferably ≥1.1 and ≤2.0.

In the esterification reactor, the composition may be subjected to a temperature of 220-270° C., preferably 240-260° C. The pressure during the esterification step in the esterification reactor is preferably atmospheric or superatmospheric, for example ≥1.0 bar during the esterification reaction. The esterification reaction may be conducted during a period of for example 2.0-5.0 hours. During the reaction, a pressure profile may be applied to the reactor. For example, the reaction may be initiated at a pressure of ≥2.0 bar, such as ≥2.0 and ≤6.0 bar, and reduced during the reaction to a pressure of ≥1.0 bar and <2.0 bar, such as ≥1.0 and ≥1.5 bar. In a particular embodiment, the esterification reaction may be conducted during a period of 2.0-5.0 hours using a pressure profile of ≥2.0 and ≤6.0 bar at the initiation of the reaction and reduction to ≥1.0 and ≤1.5 bar at the end of the reaction. During the reaction, water is formed which may be distilled out.

The esterification step results in a polyester oligomer. The polyester oligomer product may be subjected to a polycondensation step in a polycondensation reactor. The polyester oligomer is subjected to the polycondensation for a period of 20 to 100 minutes. The pressure during the polycondensation referably is subatmospheric, such as for example ≤0.01 bar, more preferably ≤0.005 bar. Application of such pressure results in reduction of volatile by-products, as a result of which the reaction shifts towards higher degrees of polymerisation. The polycondensation may be performed at a temperature of 275-300° C. The product obtained from the polycondensation may be solidified and shaped into granules.

The thermoplastic polyester copolymer obtained from the polycondensation reactor may for example have an intrinsic viscosity of ≥0.25 and ≤5 0.55 dl/g, such as of ≥0.40 and ≤0.55 dl/g.

In certain embodiments, the granules obtained from the polycondensation may be further subjected to solid state polymerisation (SSP). SSP may for example be performed in a vessel such as a tumble drier. To conduct the SSP, the contents of the tumble drier may be subjected to a temperature of for example 120-200° C., preferably 150-180°, for a period of 1-5 hrs, preferably 1-3 hours, to remove moisture, under continuous agitation and under continuous nitrogen flow. Subsequently the SSP reaction may be performed by increasing the temperature to 200-220° C. Preferably, the SSP is performed under a vacuum of ≤20 mbar, more preferably ≤10 mbar, even more preferably ≤5 mbar, under continuous agitation. SSP may for example be performed for a period of 5-50 hours, preferably 10-40 hours, to obtain a thermoplastic polyester copolymer according to the invention.

In a particular embodiment, the invention relates to a process for the production of a thermoplastic polyester copolymer wherein the process comprises the steps of first an esterification step in which a composition comprising an alkylene diol, a dicarboxylic acid or diester thereof and an alcohol having ≥3 hydroxy moieties react to form a polyester oligomer which is subsequently subjected to polycondensation at a pressure of ≤5 0.005 bar at a temperature of 275-300 to obtain a polycondensation product which upon solidification and drying is subjected to solid-state polycondensation at a temperature of 200-220° C. under a vacuum of ≤20 for a period of 5-50 hours.

The thermoplastic polyester copolymer according to the present invention may further in certain embodiments comprise ≥0.5 and ≤8.0 wt % of moieties derived from a chain extender with regard to the total weight of the thermoplastic polyester copolymer, preferably ≥0.5 and ≤4.0 wt %, even more preferably ≥1.0 and ≤2.5 wt %. The chain extender is selected from diepoxides, dianhydrides, diisocyanates, bisoxazines, bisoxazolines or bislactams.

The chain extender may for example be selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, or (2,6-dimethyl-4-((oxiranyloxy)methyl)phenoxy)oxirane. In a preferred embodiment, the chain extender is 2,2′-(1-methylethylidene)-bis(4,1-phenyleneoxy)bisoxirane. The chain extender may also be referred to as the chain extending compound.

It is preferred that the chain extending compound or the chain extender is added in a quantity of ≥0.5 and ≤8.0 wt % with regard to the total weight of the polyester to the reaction of the polyester and the chain extending compound, more preferably ≥0.5 and ≤5.0 wt %, even more preferably ≥0.5 and ≤1.0 wt %, even more preferably ≥0.6 and ≤1.0 wt %.

The invention also relates to a foam comprising the thermoplastic polyester copolymer. In the context of the present invention, a foam of the polyester may be understood to be a shapes object produced using the polyester wherein the density of the object is reduced to a density lower than the density of the polyester itself by the presence of numerous small cavities, also referred to as cells, which may or may not be interconnected, and which are dispersed throughout the mass of the polyester.

The conversion of the polyester material into a foam may occur via any process known in the art to produce foams from thermoplastic materials. Typical processes for the production of foams from thermoplastic materials that are applicable for the production of foams from the thermoplastic polyester copolymer of the present invention include extrusion moulding processes and injection moulding processes.

For example, such process may be an extrusion moulding process. Suitable extrusion moulding processes involve one single melt extruder equipped with a die suitable for foam production, or it may involve multiple melt extruders positioned in series, for example a first twin-screw extruder and a second single-screw extruder, also referred to as a tandem layout. In such tandem layout, a feed comprising the thermoplastic materials, in the case of the present invention the thermoplastic polyester copolymer, is introduced to the feed inlet of the first twin-screw extruder. The feed may comprise further components, such as for example fillers, reinforcing agents, stabilisers and further thermoplastic materials other than the thermoplastic polyester copolymer. In the twin-screw extruder, the feed material is processed to a molten, mixed composition under the influence of heat and shear.

Upon exiting the twin-screw extruder, the molten composition is introduced to the feed inlet of the second single-screw melt extruder. In this single-screw extruder, the molten material is homogenised and pressurised, and transported to a die outlet. The die outlet of the single-screw extruder is designed for production of foamed structures.

A foaming agent, also referred to as blowing agent, may be introduced into the extrusion process. Such blowing agent may be understood to be compounds that cause the expansion in the production of the foamed object. Where the extrusion process is of a tandem layout, the blowing agent may be introduced in either the first twin-screw extruder or in the second single-screw extruder. For example, the blowing agent may be introduced in the first twin-screw extruder.

The blowing agent may for example be a physical blowing agent. Physical blowing agents are to be understood to be compounds that cause an expansion thus forming a gaseous cell in the thermoplastic polyester copolymer as a result of a physical state change, such as the change from liquid state to gaseous state of a certain quantity of the blowing agent. To produce a foam of the thermoplastic polyester copolymer having a desired homogeneous cell structure in the foam, the blowing agent is to be homogeneously distributed in the molten composition. Introduction of the blowing agent in the first twin-screw extruder of the tandem extrusion layout is believed to contribute to such homogeneous distribution.

The blowing agent may for example be selected from n-pentane, cyclopentane, carbon dioxides, nitrogen, or mixtures thereof.

The blowing agent may for example be introduced in a quantity of 1.0-10.0 wt % with regard to the total weight of the thermoplastic polyester copolymer. Preferably, the blowing agent is introduced in a quantity of 1.5-5.0 wt %, more preferably 2.0-4.0 wt %.

The use of such blowing agent in such quantities is believed to contribute to obtaining a foam with a desired cell structure. The cell structure of a foam may be expressed in terms of the quantity of open cells and closed cells. It is preferred that the foam that may be produced using the thermoplastic polyester copolymer according to the present invention has an open cell fraction of ≤20.0%, more preferably ≤10.0%. The open cell fraction may be determined in accordance with ASTM D6226 (2010).

The use of such blowing agent in such quantities is also believed to contribute to obtaining a foam with a desired low density. It is preferred that the foam that may be produced using the thermoplastic polyester copolymer according to the present invention has a density of ≤100 kg/m³, more preferably ≤75 kg/m³, even more preferably ≥50 and ≤75 kg/m³. The foam density may be determined in accordance with ASTM D6226 (2010).

The invention particularly relates to a process for the production of a foam via an extrusion moulding process comprising a first twin-screw melt extruder and a second single-screw melt extruder positioned in series, wherein a feed composition comprising the thermoplastic polyester copolymer is introduced to the feed inlet of the first twin-screw melt extruder, wherein a quantity of a blowing agent is introduced to the first twin-screw melt extruder, and wherein the molten composition comprising the thermoplastic polyester copolymer and the blowing agent upon exiting the twin-screw melt extruder is fed to the feed inlet of the single-screw melt extruder and extruder from the single-screw melt extruder through a die to form a foam.

In a particular embodiment, the present invention relates to a thermoplastic polyester copolymer comprising 50-1000 ppm with regard to the total weight of the thermoplastic polyester copolymer of moieties derived from an alcohol having ≥3 hydroxy moieties wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer.

Particularly, the invention relates in one of its embodiments to a thermoplastic polyester copolymer comprising 50-1000 ppm with regard to the total weight of the thermoplastic polyester copolymer of moieties derived from an alcohol having ≥3 hydroxy moieties wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or a diester thereof comprises 4-20 carbon atoms, and wherein the alkylene diol comprises 2-10 carbon atoms.

Further particularly, the invention relates in one of its embodiments to a thermoplastic polyester copolymer comprising 50-1000 ppm with regard to the total weight of the thermoplastic polyester copolymer of moieties derived from an alcohol having ≥3 hydroxy moieties wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or a diester thereof is selected from terephthalic acid, dimethyl terephthalate, isophthalic acid, 2,6-naphthalenedicarboxylic acid, dimethyl-2,6-naphthalenedicarboxylate, 2,5-furandicarboxylic acid, dimethyl-2,5-furandicarboxylate, or succinic acid, and wherein the alkylene diol is selected from ethylene glycol, propanediol, 1,4-butanediol or cyclohexanedimethanol.

The invention in yet another embodiment relates to a thermoplastic polyester copolymer comprising 50-1000 ppm with regard to the total weight of the thermoplastic polyester copolymer of moieties derived from an alcohol having ≥3 hydroxy moieties selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxymethyl)-1,4-butanediol, tris(2-hydroxyethyl)methane, or tetrakis(2-hydroxyethyl)methane, preferably pentaerythritol, 1,1,2,2-tetra hydroxyethane, or tetrakis(2-hydroxyethyl)methane, wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or a diester thereof is selected from terephthalic acid, dimethyl terephthalate, isophthalic acid, 2,6-naphthalenedicarboxylic acid, dimethyl-2,6-naphthalenedicarboxylate, 2,5-furandicarboxylic acid, dimethyl-2,5-furandicarboxylate, or succinic acid, and wherein the alkylene dial is selected from ethylene glycol, propanediol, 1,4-butanediol or cyclohexanedimethanol.

The invention in a particular embodiment relates to a thermoplastic polyester copolymer comprising 50-1000 ppm with regard to the total weight of the thermoplastic polyester copolymer of moieties derived from an alcohol having ≥3 hydroxy moieties selected from pentaerythritol, 1,1,2,2-tetrahydroxyethane, or tetrakis(2-hydroxyethyl)methane, wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or a diester thereof is selected from terephthalic acid or dimethyl terephthalate and wherein the alkylene diol is ethylene glycol or 1,4-butanediol.

A further embodiment of the invention relates to a thermoplastic polyester copolymer comprising 50-1000 ppm with regard to the total weight of the thermoplastic polyester copolymer of moieties derived from an alcohol having ≥3 hydroxy moieties selected from pentaerythritol, 1,1,2,2-tetrahydroxyethane, or tetrakis(2-hydroxyethyl)methane, wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or a diester thereof is selected 2,5-furandicarboxylic acid or dimethyl-2,5-furandicarboxylate, and wherein the alkylene diol is ethylene glycol.

The invention in yet another embodiment relates to a thermoplastic polyester copolymer comprising 50-1000 ppm with regard to the total weight of the thermoplastic polyester copolymer of moieties derived from an alcohol having ≥3 hydroxy moieties selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxymethyl)-1,4-butanediol, tris(2-hydroxyethyl)methane, or tetrakis(2-hydroxyethyl)methane, preferably pentaerythritol, 1,1,2,2-tetrahydroxyethane, or tetrakis(2-hydroxyethyl)methane, wherein the thermoplastic polyester copolymer comprises ≥95.0 wt %, preferably ≥98.0 wt %, more preferably ≥99.0 wt % of moieties derived from a dicarboxylic acid or a diester thereof and an alkylene diol, with regard to the total weight of the thermoplastic polyester copolymer, wherein the dicarboxylic acid or a diester thereof is selected from terephthalic acid, dimethyl terephthalate, isophthalic acid, 2,6-naphthalenedicarboxylic acid, dimethyl-2,6-naphthalenedicarboxylate, 2,5-furandicarboxylic acid, dimethyl-2,5-furandicarboxylate, or succinic acid, and wherein the alkylene diol is selected from ethylene glycol, propanediol, 1,4-butanediol or cyclohexanedimethanol, wherein the molar ratio of the alkylene diol to the dicarboxylic acid or diester thereof in the polymerisation is ≥1.1 and ≤5. 3.0.

Further in an embodiment the invention also relates to a thermoplastic polyester copolymer comprising 50-1000 ppm with regard to the total weight of the thermoplastic polyester copolymer of moieties derived from an alcohol having ≥3 hydroxy moieties selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxynnethyl)-1,4-butanediol, tris(2-hydroxyethyl)methane, or tetrakis(2-hydroxyethyl)methane, preferably pentaerythritol, 1,1,2,2-tetrahydroxyethane, or tetrakis(2-hydroxyethyl)methane, wherein the thermoplastic polyester copolymer comprises ≥95.0 wt % of moieties derived from a dicarboxylic acid or a diester thereof and an alkylene diol, with regard to the total weight of the thermoplastic polyester copolymer, wherein the dicarboxylic acid or a diester thereof is selected from terephthalic acid, dimethyl terephthalate, isophthalic acid, 2,6-naphthalenedicarboxylic acid, dimethyl-2,6-naphthalenedicarboxylate, 2,5-furandicarboxylic acid, dimethyl-2,5-furandicarboxylate, or succinic acid, and wherein the alkylene diol is selected from ethylene glycol, propanediol, 1,4-butanediol or cyclohexanedimethanol, wherein the thermoplastic polyester further comprises ≥0.5 and ≤4.0 wt % of moieties derived from a chain extender with regard to the total weight of the thermoplastic polyester copolymer.

More particularly, the invention also relates in an embodiment to a thermoplastic polyester copolymer comprising 50-1000 ppm with regard to the total weight of the thermoplastic polyester copolymer of moieties derived from an alcohol having ≥3 hydroxy moieties selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxynnethyl)-1,4-butanediol, tris(2-hydroxyethyl)methane, or tetrakis(2-hydroxyethyl)methane, preferably pentaerythritol, 1,1,2,2-tetrahydroxyethane, or tetrakis(2-hydroxyethyl)methane, wherein the thermoplastic polyester copolymer comprises ≥95.0 wt % of moieties derived from a dicarboxylic acid or a diester thereof and an alkylene diol, with regard to the total weight of the thermoplastic polyester copolymer, wherein the dicarboxylic acid or a diester thereof is selected from terephthalic acid, dimethyl terephthalate, isophthalic acid, 2,6-naphthalenedicarboxylic acid, dimethyl-2,6-naphthalenedicarboxylate, 2,5-furandicarboxylic acid, dimethyl-2,5-furandicarboxylate, or succinic acid, and wherein the alkylene diol is selected from ethylene glycol, propanediol, 1,4-butanediol or cyclohexanedimethanol, wherein the thermoplastic polyester further comprises ≥0.5 and ≤4.0 wt % with regard to the total weight of the thermoplastic polyester copolymer of moieties derived from a chain extender selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, or (2,6-dimethyl-4-((oxiranyloxy)methyl)phenoxy)oxirane, preferably 2,2′-(1-methylethylidene)-bis(4,1-phenyleneoxy)bisoxirane.

In certain of its embodiments, the present invention relates to the aspects presented hereinbelow.

Aspect 1: Thermoplastic polyester copolymer comprising 50-1000 ppm with regard to the total weight of the thermoplastic polyester copolymer of moieties derived from an alcohol having ≥3 hydroxy moieties.

Aspect 2: Thermoplastic polyester copolymer according to aspect 1 wherein the thermoplastic polyester copolymer is a polymer selected from a poly(ethylene terephthalate) copolymer, a poly(trimethylene terephthalate) copolymer, a poly(butylene terephthalate) copolymer, a poly(ethylene naphthalate) copolymer, or a poly(ethylene furanoate) copolymer,

Aspect 3: Thermoplastic polyester copolymer according to any one of aspects 1-2, wherein the alcohol is a compound according to the formula:

[R1OHₙ

wherein R1 is a moiety comprising 1-10 carbon atoms and wherein n is an integer ≥3 and ≤6.

Aspect 4: Thermoplastic polyester copolymer according to claim 3, wherein R1 is a moiety selected from methyl, ethyl, propyl, tert-butyl, neopentyl, or hexamethylethyl.

Aspect 5: Thermoplastic polyester copolymer according to any one of aspects 1-3, wherein the alcohol having ≥3 hydroxy moieties is selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxymethyl)-1,4-butanediol, tris(2-hydroxyethyl)methane, or tetrakis(2-hydroxyethyl)methane.

Aspect 6: Thermoplastic polyester copolymer according to any one of aspects 1-5, wherein the thermoplastic polyester copolymer comprises ≥95.0 wt % of moieties derived from ethylene glycol and terephthalic acid or a diester thereof, with regard to the total weight of the thermoplastic polyester copolymer.

Aspect 7: Thermoplastic polyester copolymer according to any one of aspects 1-6, wherein the thermoplastic polyester copolymer has an intrinsic viscosity of ≥0.60 dl/g and ≤2.00 dl/g as determined in accordance with ASTM D2857-95 (2007).

Aspect 8: Thermoplastic polyester copolymer according to any one of aspects 1-7, wherein the thermoplastic polyester copolymer comprises ≥0.5 and ≤8.0 wt % of moieties derived from a chain extender with regard to the total weight of the thermoplastic polyester copolymer.

Aspect 9: Thermoplastic polyester copolymer according to aspect 8 wherein the chain extender is selected from diepoxides, dianhydrides, diisocyanates, bisoxazines, bisoxazolines or bislactams.

Aspect 10: Thermoplastic polyester copolymer according to aspect 8 wherein the chain extender is a compound selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, or (2,6-dimethyl-4-((oxiranyloxy)methyl)phenoxy)oxirane, preferably 2,2′-(1-methylethylidene)-bis(4,1-phenyleneoxy)bisoxirane.

Aspect 11: Process for the production of a thermoplastic polyester copolymer according to any one of aspects 1-10 wherein the process comprises the steps of first an esterification step in which a composition comprising an alkylene diol, a dicarboxylic acid or diester thereof and an alcohol having ≥3 hydroxy moieties react to form a polyester oligomer which is subsequently subjected to polycondensation at a pressure of ≤0.005 bar at a temperature of 275-300 to obtain a polycondensation product which upon solidification and drying is subjected to solid-state polycondensation at a temperature of 200-220° C. under a vacuum of ≤20 for a period of 5-50 hours.

Aspect 12: Foam comprising the thermoplastic polyester copolymer according to any of aspects 1-10.

Aspect 13: Foam according to aspect 12 having a density of <100 kg/m³as determined in accordance with ASTM D6226 (2010).

Aspect 14: Foam according to any of aspects 12-13 having an open cell content of 15.0% as determined in accordance with ASTM D6226 (2010).

Aspect 15: Process for the production of a foam according to any one of aspects 12-14 via an extrusion moulding process comprising a first twin-screw melt extruder and a second single-screw melt extruder positioned in series, wherein a feed composition comprising the thermoplastic polyester copolymer according to any one of claims 1-10 is introduced to the feed inlet of the first twin-screw melt extruder, wherein a quantity of a blowing agent is introduced to the first twin-screw melt extruder, and wherein the molten composition comprising the thermoplastic polyester copolymer and the blowing agent upon exiting the twin-screw melt extruder is fed to the feed inlet of the single-screw melt extruder and extruder from the single-screw melt extruder through a die to form a foam.

The invention will now be illustrated by the following non-limiting examples.

A poly(ethylene terephthalate) copolymer was produced via a process involving first a melt polymerisation stage and a subsequent solid state polymerisation stage.

The melt polymerisation was performed as a batch reaction in a reaction vessel having a volume sufficient to produce 50 kg of PET copolymer per batch.

A formulation of raw materials according to the table below was introduced into the reaction vessel:

TABLE I
raw material formulation

| | | Quantity in view | | |
|---|---|---|---|---|
| Compound | CAS reg. nr. | of PET formed | Formulation 1 | |
| Terephthalic acid | 100-21-0 | | 43.3 | kg |
| Monoethylene | 107-21-1 | | 20.8 | kg |
| glycol | | | | |
| Antimony | 6923-52-0 | 275 ppm of Sb in | 34.20 | g |
| triacetate | | PET | | |
| Pentaerythritol | 115-77-5 | 250 ppm in PET | 12.50 | g |
| Cobalt acetate | 6147-53-1 | 16 ppm of Co in | 3.40 | g |
| tetrahydrate | | PET | | |

The temperature inside the reaction vessel was increased to 250° C. such that esterification occurs. Pressure during esterification was set at 4.0 bar with gradual reduction to 1.0 bar during the course of the reaction, which was allowed to proceed for between 2 and 3 hours. The water formed during esterification was removed and the obtained PET oligomeric product was placed in a second reaction vessel for polycondensation. A quantity of further additives was added to the second reaction vessel according to table II.

TABLE II
additives for polycondensation

| | | Quantity in view | |
|---|---|---|---|
| Compound | CAS reg. nr. | of PET formed | Formulation 1 |
| Zinc acetate dihydrate | 5970-45-6 | 25 ppm of Zn in | 4.25 g |
| | | PET | |
| Triethyl phosphate | 78-40-0 | 20 ppm of P in | 5.87 g |
| | | PET | |

The temperature was increased to 280° C. and polycondensation was performed at a pressure of 2.0 mbar under continuous agitation of the reaction vessel. Polycondensation was performed under continuous removal of monoethylene glycol until target torque achievement. After completion of the polycondensation reaction, the polymeric product was pumped out of the reactor and extruded through a die plate to form polymer strands, which were cooled to solidify in a water bath and cut to form granules of amorphous PET copolymer having a diameter of 2-5 mm.

The granules were further subjected to solid state polymerisation (SSP). The granules were fed into a tumble drier acting as SSP reactor. The temperature was increased to 160° C. and maintained for 2 hrs to remove moisture, under continuous agitation and under continuous nitrogen flow. Subsequently the SSP reaction was performed by increasing the temperature to 205° C. and applying a vacuum of 1 mbar under continuous agitation. SSP was performed for a period of 26 hours to obtain a PET copolymer having an intrinsic viscosity of 1.0 dl/g as determined in accordance with ASTM D2857-95 (2007).

The PET copolymer of formulation 1 as obtained via the method described above (further also referred to as CoPET-1) and commercial PET homopolymers were further processed into foamed materials in a number of examples with varying quantities of a chain extender compound Masspet 2834NF, a PET masterbatch comprising 50 wt % of a chain extender, obtainable from Point Plastics Srl. of Italy. Formulations of compounded examples are presented in table III below.

The foamed materials were produced using a tandem foam line comprising a twin screw Berstorff ZE40 extruder in series with a single screw Berstorff KE90 extruder. Formulations according to table III were fed to the twin screw extruder for mixing, where the material exiting the twin screw extruder were fed to the single screw extruder for cooling. The twin screw extruder was operated at a temperature profile of 50° C. at the feed section up to 300° C. at the outlet. The speed of the twin screw extruder was set at 135 rpm, and material throughput was 70 kg/h. The cyclopentane blowing agent was introduced in the twin screw extruder.

The temperature profile of the single screw extruder was from 80° C. at the material inlet to 250° C. at the die outlet. Speed of the single screw extruder was set at 10 rpm.

A slit die at the outlet of the single screw extruder having a die gap of 2.5 mm and a width of 180 mm was used to produce foam sheets. A die with 3 rows of holes where each row 17 holes each of 8 mm diameter, the holes distributed over a width of 180 mm, was used to produce foam boards. Upon exiting the die, the foamed materials were cooled.

TABLE III
compounding formulations.

| Example | CoPET-1 | BC112 | HS088 | Masspet | CP |
|---|---|---|---|---|---|
| 1 | 98.8 | — | — | 1.2 | 4.43 |
| 2 | 98.5 | — | — | 1.5 | 4.43 |
| 3 | 98.2 | — | — | 1.8 | 4.43 |
| 4 | 98.5 | — | — | 1.5 | 3.13 |
| 5 | 98.4 | — | — | 1.6 | 3.13 |
| 6 | 98.2 | — | — | 1.8 | 3.13 |
| 7 | — | 100.0 | — | — | 4.43 |
| 8 | — | 97.5 | — | 2.5 | 3.0 |
| 9 | — | 97.5 | — | 2.5 | 4.0 |
| 10 | — | 97.5 | — | 2.5 | 4.43 |
| 11 | — | 97.5 | — | 2.5 | 5.0 |
| 12 | 100.0 | — | — | — | 4.43 |
| 13 | — | 100.0 | — | — | 3.13 |
| 14 | — | 97.5 | — | 2.5 | 3.13 |
| 15 | — | 97.3 | — | 2.7 | 3.38 |
| 16 | — | — | 100.0 | — | 3.13 |
| 17 | — | — | 97.5 | — | 3.13 |
| 18 | — | — | 97.3 | — | 3.38 |
| 19 | 100.0 | — | — | — | 3.13 |

The quantities in table III indicate parts by weight. BC 112 is a PET homopolymer having an intrinsic viscosity of 0.8 dl/g. HC088 is a PET homopolymer having an intrinsic viscosity of 0.92 dl/g. Both are obtainable from SABIC. CP is cyclopentane, Examples 1-6 reflect the invention, examples 7-19 are presented for comparative purposes.

Of the foamed materials prepared according to the formulations of table III, a number of properties were determined as presented below in table IV.

TABLE IV
properties of foamed materials.

| | | Foam density | Open cell | Average foam | Fmax at 80% |
|---|---|---|---|---|---|
| Example | Foamable | (kg/m³) | fraction (%) | thickness (mm) | strain (MPa) |
| 1 | Y | 60 | 29 | 26.3 | 0.64 |
| 2 | Y | 54 | 5.8 | 28.8 | 0.64 |
| 3 | Y | 61 | 22.6 | 27.6 | 0.70 |
| 4 | Y | 87 | 0.02 | 3.04 | 1.66 |
| 5 | Y | 71 | 10.8 | 4.15 | 1.44 |
| 6 | Y | 90 | 0.02 | 2.54 | 1.84 |
| 7 | N | — | — | | |
| 8 | Y | 79 | 6.4 | 23.2 | 1.20 |
| 9 | Y | 81 | 4.4 | 24.8 | 1.20 |
| 10 | Y | 55 | 12.3 | 25.2 | 0.63 |
| 11 | Y | 56 | 28.8 | 25.6 | 0.55 |
| 12 | N | — | — | | |
| 13 | N | — | — | | |
| 14 | Y | 117 | 5.4 | 2.40 | 2.70 |
| 15 | Y | 73 | 9.3 | 2.48 | 1.80 |
| 16 | N | — | — | | |
| 17 | Y | 111 | 15.6 | 2.50 | 2.90 |
| 18 | Y | 101 | 0.12 | 3.38 | 1.95 |
| 19 | N | — | — | | |

Foamability indicated the ability to produce a foamed material according to the formulation of the particular example. Table IV shows that the formulations of examples 7, 13 and 16 (commercial PET homopolymers) as well as 12 and 19 (PET copolymers according to the invention, no branching agent added) did not allow for the production of any foamed material.

The foam density and the fraction of open cells were determined using a pycnometer in accordance with ASTM D6226 (2010). The compressive strength (Fnnax) was determined in accordance with ASTM D1621 (2010) using a Zwick tensile tester where the samples were stacks of 5 foam sheets or boards each having a diameter of 4 cm.

In examples 1-3 and 8-11, foam boards were produced according to the method for producing foam boards as presented above. In examples 4-6, 14-15 and 17-18 foam sheets were produced according to the method for producing foam sheets as presented above. The average foam thickness for those examples reflects the board or sheet thickness, whatever applicable.

The above examples show that using the PET copolymers according to the present invention, at given quantity of blowing agent, the quantity of chain extender that needs to be used to produce a foam material of desired properties is far less than would in the case where commercial homopolymer PET materials are used that do not contain units derived from a compound according to formula I, such as pentaerythritol, as do the PET copolymers of the present invention.

1. A thermoplastic polyester copolymer comprising 50-1000 ppm with regard to the total weight of the thermoplastic polyester copolymer of moieties derived from an alcohol having ≥3 hydroxy moieties, wherein the thermoplastic polyester copolymer comprises ≥0.5 and ≤8.0 wt % of moieties derived from a chain extender with regard to the total weight of the thermoplastic polyester copolymer.

2. The thermoplastic polyester copolymer according to claim 1 wherein the chain extender is selected from diepoxides, dianhydrides, diisocyanates, bisoxazines, bisoxazolines or bislactams.

3. The thermoplastic polyester copolymer according to claim 1, wherein the chain extender is a compound selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, or (2,6-dimethyl-4-((oxiranyloxy)methyl)phenoxy)oxirane, ((oxiranyloxy)methyl)phenoxy)oxirane.

4. The thermoplastic polyester copolymer according to claim 1, wherein the chain extender is 2,2′-(1-methylethylidene)-bis(4,1-phenyleneoxy)bisoxirane.

5. The thermoplastic polyester copolymer according to claim 1, wherein the thermoplastic polyester copolymer is a polymer selected from a poly(ethylene terephthalate) copolymer, a poly(trimethylene terephthalate) copolymer, a poly(butylene terephthalate) copolymer, a poly(ethylene naphthalate) copolymer, or a poly(ethylene furanoate) copolymer,

6. The thermoplastic polyester copolymer according to claim 1, wherein the alcohol is a compound according to the formula:
[R1┐OHₙ
wherein R1 is a moiety comprising 1-10 carbon atoms and wherein n is an integer ≥3 and ≤6.

7. The thermoplastic polyester copolymer according to claim 6, wherein R1 is a moiety selected from methyl, ethyl, propyl, tert-butyl, neopentyl, or hexamethylethyl.

8. The thermoplastic polyester copolymer according to claim 1, wherein the alcohol having ≥3 hydroxy moieties is selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxymethyl)-1,4-butanediol, tris(2-hydroxyethyl)methane, or tetrakis(2-hydroxyethyl)methane.

9. Thermoplastic The thermoplastic polyester copolymer according to claim 1, wherein the thermoplastic polyester copolymer comprises ≥95.0 wt % of moieties derived from ethylene glycol and terephthalic acid or a diester thereof, with regard to the total weight of the thermoplastic polyester copolymer.

10. The thermoplastic polyester copolymer according to claim 1, wherein the thermoplastic polyester copolymer has an intrinsic viscosity of ≥0.60 dl/g and ≤2.00 dl/g as determined in accordance with ASTM D2857-95 (2007).

11. A process for the production of a thermoplastic polyester copolymer according to claim 1, wherein the process comprises the steps of first an esterification step in which a composition comprising an alkylene diol, a dicarboxylic acid or diester thereof and an alcohol having ≥3 hydroxy moieties react to form a polyester oligomer which is subsequently subjected to polycondensation at a pressure of ≤0.005 bar at a temperature of 275-300° C. to obtain a polycondensation product which upon solidification and drying is subjected to solid-state polycondensation at a temperature of 200-220° C. under a vacuum of ≤20 for a period of 5-50 hours.

12. A foam comprising the thermoplastic polyester copolymer according to claim 1.

13. The foam according to claim 12 having a density of <100 kg/m³ as determined in accordance with ASTM D6226 (2010).

14. The foam according to claim 12 having an open cell content of ≤15.0% as determined in accordance with ASTM D6226 (2010).

15. A process for the production of a foam via an extrusion moulding process comprising a first twin-screw melt extruder and a second single-screw melt extruder positioned in series, wherein a feed composition comprising the thermoplastic polyester copolymer according to claim 1 is introduced to the feed inlet of the first twin-screw melt extruder, wherein a quantity of a blowing agent is introduced to the first twin-screw melt extruder, and wherein the molten composition comprising the thermoplastic polyester copolymer and the blowing agent upon exiting the twin-screw melt extruder is fed to the feed inlet of the single-screw melt extruder and extruder from the single-screw melt extruder through a die to form a foam.

16. The thermoplastic polyester copolymer according to claim 1, wherein the chain extender is a compound selected from 2,2′-methylene-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bisoxirane, 2,2′-ethylidene-bis(4,1-phenyleneoxy)bisoxirane, 2,2′-(1-methylethylidene)-bis(4,1-phenyleneoxy)bis(3-methyl-oxirane), 4,4′-bis(1,2-epoxypropoxy)biphenyl, 2,2′-((1,1′-biphenyl])-4,4′-diylbis(oxy))bisoxirane, 1,4-bis(1,2-epoxypropoxy)benzene, 2,2′-(1,4-phenylenebis(oxy)bisoxirane, 2,2′-((1,1′-binaphthalene)-2,2′-diylbis(oxy))bisoxirane, ((6′-oxiranylmethoxy(2,2′-binaphthalene)-6-yl)oxy)oxirane, 2,2′-(1,6-naphthalenediylbis(oxy))bisoxirane, 2,2′-((1,1′-biphenyl)-4,4′-diylbis(oxy))bis(2-methyl-oxirane), 2,2′-(2,6-naphthalenediylbis(oxy))bis(2-methyl-oxirane), 2,2′-(methylenebis(4,1-phenyleneoxy))bis(2-methyl-oxirane), 2,2′-(1,4-phenylenebis(oxy))bis(2-methyl-oxirane), (2-methyl-4-((oxiranyloxy)methyl)phenoxy)oxirane, or (2,6-dimethyl-4-((oxiranyloxy)methyl)phenoxy)oxirane;
wherein the thermoplastic polyester copolymer is a polymer selected from a poly(ethylene terephthalate) copolymer, a poly(trimethylene terephthalate) copolymer, a poly(butylene terephthalate) copolymer, a poly(ethylene naphthalate) copolymer, or a poly(ethylene furanoate) copolymer;
wherein the alcohol is a compound according to the formula:
[R1┐OHₙ
wherein R1 is a moiety comprising 1-10 carbon atoms and wherein n is an integer ≥3 and ≤6;
wherein the thermoplastic polyester copolymer comprises ≥95.0 wt % of moieties derived from ethylene glycol and terephthalic acid or a diester thereof, with regard to the total weight of the thermoplastic polyester copolymer; and
wherein the thermoplastic polyester copolymer has an intrinsic viscosity of ≥0.60 dl/g and ≤2.00 dl/g as determined in accordance with ASTM D2857-95 (2007).

17. The thermoplastic polyester copolymer according to claim 16,
wherein R1 is a moiety selected from methyl, ethyl, propyl, tert-butyl, neopentyl, or hexamethylethyl; and
wherein the chain extender is 2,2′-(1-methylethylidene)-bis(4,1-phenyleneoxy)bisoxirane.

18. The thermoplastic polyester copolymer according to claim 17, wherein the alcohol having ≥3 hydroxy moieties is selected from tetrahydroxymethane, trihydroxymethane, 1,1,2,2-tetrahydroxyethane, hexahydroxyethane, glycerol, 1,3,5-pentanetriol, xylitol, pentaerythritol, 2,2,3,3-tetrakis(hydroxymethyl)-1,4-butanediol, 2,3-bis(hydroxymethyl)-1,4-butanediol, tris(2-hydroxyethyl)methane, or tetrakis(2-hydroxyethyl)methane.
